(19) United States
(12) Patent Application Publication
(10) Pub. No.: US 2016/0113245 A1
(43) Pub. Date: Apr. 28, 2016

(54) ANIMAL COLLAR AND LEASH ASSEMBLY

(71) Applicant: Jarrod Lee Swanger, Greensboro, NC (US)

(72) Inventor: Jarrod Lee Swanger, Greensboro, NC (US)

(21) Appl. No.: 14/522,085

(22) Filed: Oct. 23, 2014

(51) Int. Cl. A01K 27/00

(52) U.S. Cl. CPC A01K 27/004; A01K 27/001

(57) ABSTRACT

A leash and collar assembly is provided. The assembly includes a looped collar formed to fit around a neck or a body of an animal. The assembly may further include a housing attached to the looped collar. A leash may include a first end and a second end. The first end of the leash is attached within the housing, and the second end of the leash is outside of the housing. The leash includes a retracted position with a substantial portion of the leash within the housing, and an extended position with the substantial portion of the leash outside of the housing.

### BACKGROUND OF THE INVENTION

The present invention relates to collars and leashes for pets and, more particularly, to a collar and leash combination.

A dog collar is a piece of material put around the neck of a dog. A collar may be used for control, identification, fashion, or other purposes. Identification tags and medical information are often placed on dog collars. Collars are also useful for controlling a dog manually, as they provide a handle for grabbing. Collars are often used in conjunction with a leash. Purchasing both a collar and a leash for a dog may be expensive. Further, the user must keep track of both items.

As can be seen, there is a need for an improved dog collar and leash assembly.

### SUMMARY OF THE INVENTION

In one aspect of the present invention, a leash and collar assembly comprises: a looped collar formed to fit around a neck or a body of an animal; a housing attached to the looped collar; and a leash comprising a first end attached within the housing, and a second end outside of the housing, wherein the leash comprises a retracted position comprising a substantial portion of the leash within the housing, and an extended position comprising the substantial portion of the leash outside of the housing.

These and other features, aspects and advantages of the present invention will become better understood with reference to the following drawings, description and claims.

### BRIEF DESCRIPTION OF THE DRAWINGS

FIG. 1 is a perspective view of the present invention with the leash in the extended position;

FIG. 2 is a perspective view of the present invention with the leash in the retracted position; and

FIG. 3 is a perspective view of the present invention, illustrating a connector of the handle and the leash.

### DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a pet collar with a built in leash. The present invention combines a collar with the convenience of a retractable leash built in utilizing a retractable housing to reel the leash back in when not in use.

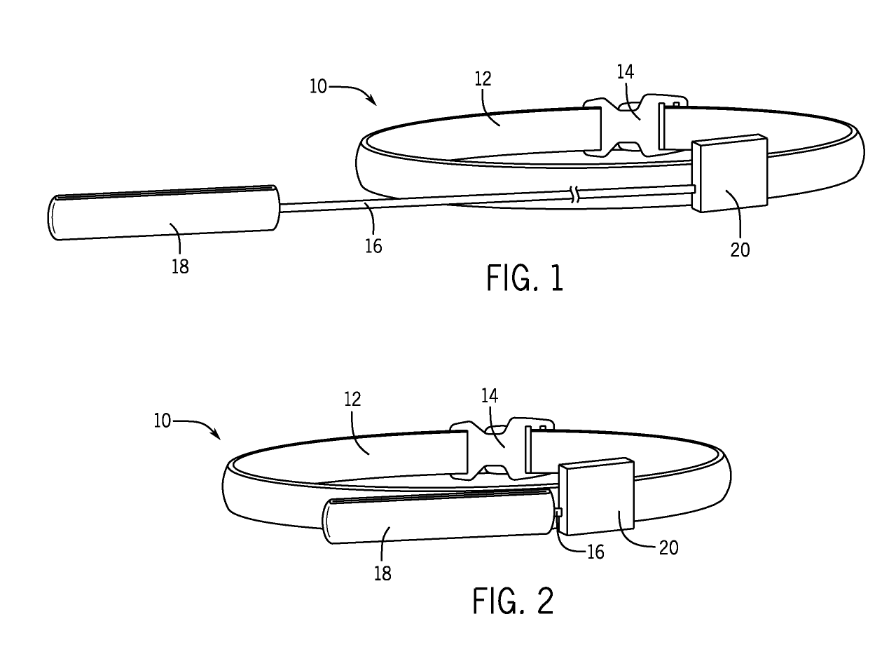

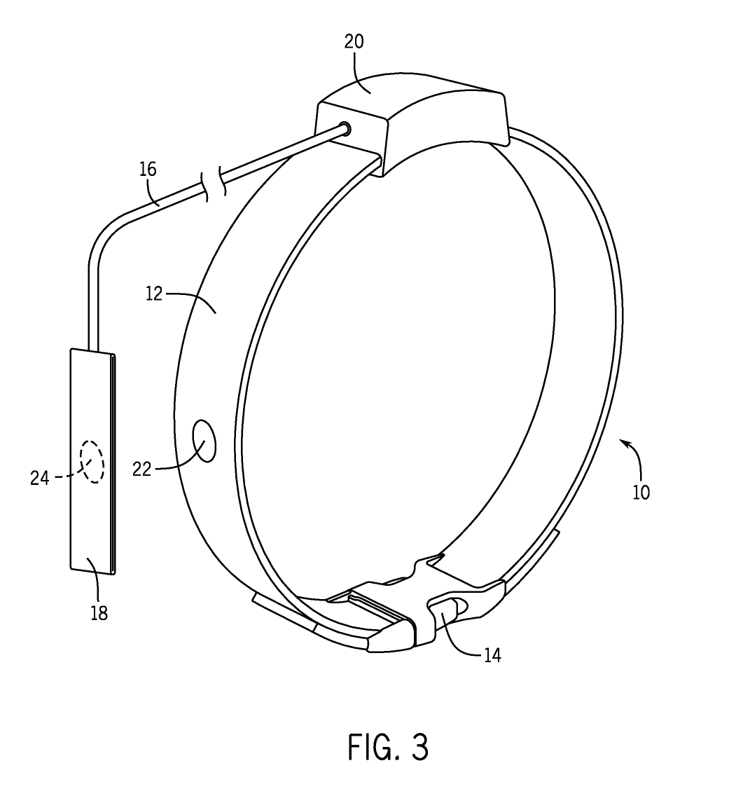

Referring to FIGS. 1 through 3, the present invention includes a leash and collar assembly 10. The assembly 10 includes a looped collar 12 formed to fit around a neck or a body of an animal. The assembly 10 may further include a housing 20 attached to the looped collar 12. A leash 16 may include a first end and a second end. The first end of the leash 16 is attached within the housing 20, and the second end of the leash 16 is outside of the housing 20. The leash 16 includes a retracted position with a substantial portion of the leash 16 within the housing 20, and an extended position with the substantial portion of the leash 16 outside of the housing 20.

The collar 12 of the present invention may fit around animals, such as pets. The collar 12 of the present invention may be a standard collar or may be an animal harness. In certain embodiments, the collar 12 may include a first end and a second end. The first end and the second end may releasably attach together via a clip 14. The clip 14 may be adjustable. Therefore, the collar 12 may adjust in length to fit different sized pets.

In certain embodiments, the leash 16 is spring biased in the retracted position. In such embodiments, the housing 20 may include a spring mechanism and a rotatable rod. The first end of the leash 16 may be attached to the rod. In the retracted position, the leash 16 may coil around the rotatable rod and be secured within the housing 20. When the present invention is ready to use, a user may grasp the second end of the leash 16 and pull the leash 16 out of the housing 20, thereby rotating the rod. In certain embodiments, the present invention may include a locking mechanism to lock the leash 16 in the extended position. Once finished with the leash 16, the user may simply release the leash 16 and the leash 16 may roll back up over the rod.

In certain embodiments, a handle 18 may be attached to the second end of the leash 16. Therefore, a user may easily grasp the leash 16 by the handle 18. In certain embodiments, a connector 22, 24 may releasably attach the handle 18 and the looped collar 12. For example, a first magnetic piece 22 may be attached to the leash 16 and a second magnetic piece 24 may be attached to the handle 18. The first and second magnetic pieces 22, 24 may attract one another and attach when the leash 16 is in the retracted position. The connectors 22, 24, are not limited to magnets, and may include a hook 22 and loop 24 fasteners, a male 22 and female 24 snap button, and the like. Therefore the handle 24 may be secured to the collar 12 in the retracted position.

While in use, the collar 12 may be wrapped around a neck of a pet and the clips 14 may be snapped together. The handle 16 may be grasped, and the leash 16 may be pulled out of the housing 20. The leash 16 may be locked in the extended position. The user may then walk the dog or other animal. Once finished, the user may unlock the locking mechanism and allow the leash 16 to roll back up into the housing 20. The connector 22, 24 may connect the handle 18 and the leash 20, and the assembly 10 may be stored away.

It should be understood, of course, that the foregoing relates to exemplary embodiments of the invention and that modifications may be made without departing from the spirit and scope of the invention as set forth in the following claims.

What is claimed is:

1. A leash and collar assembly comprising:
a looped collar formed to fit around a neck or a body of an animal;
a housing attached to the looped collar; and
a leash comprising a first end attached within the housing, and a second end outside of the housing,
wherein the leash comprises a retracted position comprising a substantial portion of the leash within the housing, and an extended position comprising the substantial portion of the leash outside of the housing.

2. The assembly of claim 1, wherein the leash is spring biased in the retracted position.

3. The assembly of claim 1, further comprising a handle attached to the second end of the leash.

4. The assembly of claim 3, further comprising a connector releasably attaching the handle and the looped collar.

5. The assembly of claim 4, wherein the connector is one of a pair of magnets, a hook and loop fastener, and a snap button.

6. The assembly of claim 1, wherein the looped collar comprises a first end and a second end releasably attachable to one another by an adjustable clip.
